(19) United States
(12) Patent Application Publication
(10) Pub. No.: US 2020/0210805 A1
(43) Pub. Date: Jul. 2, 2020

(54) Neural Network Generator

(71) Applicant: NVIDIA Corporation, Santa Clara, CA (US)

(72) Inventors: Marek Drozdowski, Szczecin (PL); Micah Villmow, Santa Clara, CA (US)

(21) Appl. No.: 16/237,508

(22) Filed: Dec. 31, 2018

(51) Int. Cl. G06N 3/04; G06F 17/11; G06F 17/16; G06N 7/00

(52) U.S. Cl. CPC G06N 3/04; G06N 7/00; G06F 17/16; G06F 17/11

(57) ABSTRACT

A neural network is a collection of interconnected nodes, where each of the nodes processes input data and outputs a result of the processing to any other nodes connected to it. The neural network is typically composed of various layers that perform different processing tasks on their inputs. Systems, methods, and computer program products are provided for generating one or more functional layers in a neural network.

### TECHNICAL FIELD

One embodiment relates to generating a neural network.

### BACKGROUND

In general, a neural network is a collection of interconnected nodes, where each of the nodes processes input data and outputs a result of the processing to any other nodes connected to it. The neural network is typically composed of various layers that perform different processing tasks on their inputs. Unfortunately, current techniques to generate neural networks generally use tedious processes that may not guarantee a valid working result. There is a need for addressing these issues and/or other issues associated with the prior art.

### BRIEF DESCRIPTION OF THE DRAWINGS

FIG. 1 illustrates a flowchart of a method for generating at least a portion of a neural network, in accordance with one embodiment.

FIG. 2A illustrates a diagram of a directed graph representation of a portion of a neural network constructed from a matrix, in accordance with one embodiment.

FIG. 2B illustrates the directed graph representation of FIG. 2A with input and output nodes connected to the portion of the neural network, in accordance with one embodiment.

FIG. 2C illustrates the directed graph representation of FIG. 2B with an indication of calculated node volumes, in accordance with one embodiment.

FIG. 2D illustrates the directed graph representation of FIG. 2C with an indication of determined node dimensions, in accordance with one embodiment.

FIG. 2E illustrates a function for the connection between node X1 and node X2 in the directed graph representation of FIG. 2D, in accordance with one embodiment.

FIG. 2F illustrates a function for the connection between node X2 and node X3 in the directed graph representation of FIG. 2D, in accordance with one embodiment.

FIG. 2G illustrates an exemplary neural network portion resulting, in part, from the function in FIG. 2E and the function in FIG. 2F, in accordance with one embodiment.

FIG. 2H illustrates a directed graph representation of a sub-graph constructed from a matrix for the portion of the neural network of FIG. 2G, in accordance with one embodiment.

FIG. 2I illustrates the directed graph representation of FIG. 2H with an indication of calculated node volumes and determined node dimensions, in accordance with one embodiment.

FIG. 3 illustrates a parallel processing unit, in accordance with an embodiment.

FIG. 4A illustrates a general processing cluster within the parallel processing unit of FIG. 3, in accordance with an embodiment.

FIG. 4B illustrates a memory partition unit of the parallel processing unit of FIG. 3, in accordance with an embodiment.

FIG. 5A illustrates the streaming multi-processor of FIG. 4A, in accordance with an embodiment.

FIG. 5B is a conceptual diagram of a processing system implemented using the PPU of FIG. 3, in accordance with an embodiment.

FIG. 5C illustrates an exemplary system in which the various architecture and/or functionality of the various previous embodiments may be implemented.

FIG. 6 is a conceptual diagram of a graphics processing pipeline implemented by the PPU of FIG. 3, in accordance with an embodiment.

### DETAILED DESCRIPTION

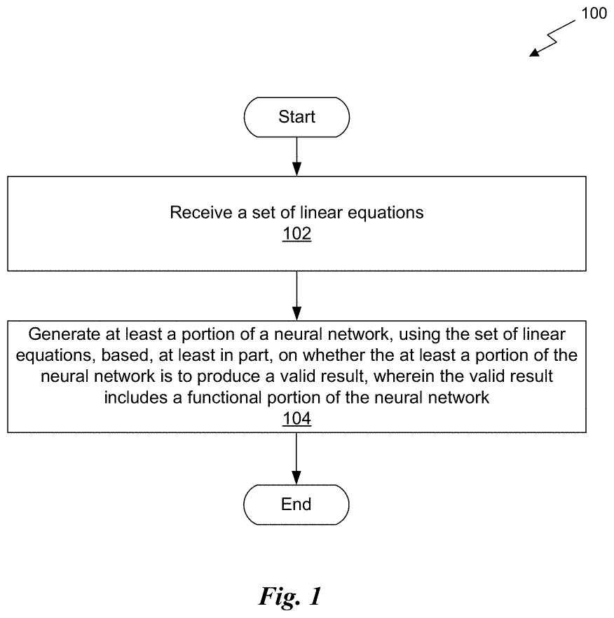

FIG. 1 illustrates a flowchart of a method 100 for generating at least a portion of a neural network, in accordance with one embodiment. The “portion” of the neural network described hereinbelow may refer to a sub-part of the neural network that is connected to one or more other sub-parts of the neural network, or to an entirety of the neural network. In one embodiment, the method 100 may be performed by one or more processing units, and/or may also be performed by a program, custom circuitry, or by a combination thereof. In one embodiment, the method 100 may be executed by a GPU (graphics processing unit), CPU (central processing unit), or any processor capable of performing arithmetic computations, such as those described below with reference to one or more of the remaining Figures. Furthermore, persons of ordinary skill in the art will understand that any system that performs method 100 is within the scope and spirit of embodiments described herein.

In operation 102, a set of linear equations are received as input. In one embodiment, the set of linear equations includes integer linear equations. In one embodiment, a number of linear equations in the set of linear equations is equal to a number of anchor nodes to be included in the portion of the neural network to be generated using the set of linear equations. In one embodiment, each linear equation in the set of linear equations includes a plurality of variables each representative of a corresponding anchor node to be included in the portion of the neural network. In one embodiment, a coefficient of each of the variables is defined based on a predefined value range (e.g., in a pseudo-random manner). In one embodiment, one of the linear equations in the set of linear equations is configured to equal a parameter representing a negative of a volume of an input one of the anchor nodes or a volume of an output one of the anchor nodes, and remaining linear equations in the set of linear equations are configured to equal zero.

In one embodiment, the set of linear equations are generated from a matrix of values. In one embodiment, the matrix is a diagonal matrix. In one embodiment, the matrix is generated based on defined constraints. In one embodiment, the defined constraints include a size of the matrix. In one embodiment, the matrix is an N×M matrix, with N and M defined. In one embodiment, the matrix is an N×M matrix, with N and M selected in a pseudo-random manner based on a defined size range for N and M. In one embodiment, a number of columns in the matrix is equivalent to a number of anchor nodes to be included in the portion of the neural network. In one embodiment, a number of rows in the matrix of values is the same as the number of columns in the matrix of values. In one embodiment, at least a portion of the values in the matrix define the connections between the anchor nodes.

In one embodiment, the defined constraints include a range for one or more of the values included in the matrix. In one embodiment, the defined constraints prohibit certain values from being included in the matrix, such as numbers with a non-terminating decimal. In one embodiment, the set of integer linear equations includes a linear equation determined for each row of the matrix. In on embodiment, each value in the row is a coefficient for a respective anchor node.

In operation 104, at least a portion of the neural network is generated, using the set of linear equations, based, at least in part, on whether the at least a portion of the neural network is to produce a valid result, wherein the valid result includes a functional portion of the neural network. In one embodiment, the portion of the neural network includes the anchor nodes (e.g. nodes at a same particular level in the neural network) and connections between the anchor nodes.

In one embodiment, the portion of the neural network may be generated using the set of linear equations by determining the anchor nodes for the portion of the neural network and determining the connections between the anchor nodes. In one embodiment, determining the anchor nodes for the intermediate layer may include determining a number of anchor nodes for the portion of the neural network, a volume of each of the anchor nodes, and dimensions corresponding to the volume for each of the anchor nodes.

In one embodiment, the volume of each of the anchor nodes is determined by solving the set of integer linear equations. In one embodiment, the set of linear equations are solved by reducing the linear equations such that each reduced linear equation represents a volume of a respective anchor node as a function of a volume of one or more input ones of the anchor nodes (e.g. some coefficient value multiplied by the volume of the one or more input anchor nodes).

In one embodiment, solving the set of linear equations to determine the volume of each of the anchor nodes includes solving the set of linear equations, or the reduced linear equations, to determine integer scale factors for the anchor nodes (e.g., integer multipliers that convert a coefficient of the reduced linear equations to a lowest possible integer), determining a minimum valid input volume for the one or more input anchor nodes based on the integer scale factors (e.g., as the least common multiple of the integer multipliers), selecting a volume for each of the one or more input anchor nodes, based on the minimum valid volume determined for each of the one or more input anchor nodes, and further calculating a volume for each of the remaining anchor nodes, based on the selected volume for each of the one or more input anchor nodes and the reduced linear equations.

In one embodiment, the dimensions corresponding to the volume for each of the anchor nodes may represent a shape of the anchor node. In one embodiment, the dimensions may be a sequence of values, with a product equivalent to the volume of the anchor node. One or more of the anchor nodes may have a same number of dimensions, while other ones of the anchor nodes may have a different number of dimensions.

In one embodiment, the portion of the neural network may be generated using pseudo-random values selected within a defined range of value. In one embodiment, the pseudo-random values may be used to generate the matrix. In one embodiment, the pseudo-random values may be used to determine the anchor node dimensions.

In one embodiment, the portion of the neural network is further generated by determining a function for each of the connections between the anchor nodes, based on the dimensions of the anchor nodes linked by the connection. As noted above, a particular connection connects, or links, two anchor nodes, hereinafter referred to as a source anchor node from which the connection is directed towards a destination anchor node. Thus, the source anchor node provides input to the function, and the output of the function is provided to the destination anchor node. The function is accordingly applied to the dimensions of the source anchor node.

In one embodiment, the function includes one or more operations (e.g. that execute in sequence). The one or more operations transform the input to generate the output, where the output matches the dimensions of the destination anchor node. In other words, the one or more operations transform the dimensions of the source anchor node to the dimensions of the destination anchor node. The operations may include one or more operations to be tested using the neural network, one or more reshape operations that changes the number of dimensions of the input, one or more reduce operations that reduces dimension values (e.g. subtracts some amount from one or more of the dimension values), and/or one or more add operations that adds dimension values (e.g. adds some amount to one or more of the dimension values).

In one embodiment, the function is configured (e.g. the operations therein selected) for a connection based on the dimensions of the two anchor nodes linked by the connection. In other words, the function is configured such that, when applied to the dimensions of the source anchor node, the function produces the dimensions of the destination anchor node. Configuring the function based on the given dimensions of the two connected anchor nodes allows the method 100 to focus on exercising diverse dimensionality between the anchor nodes.

In one other embodiment, the dimensions of the two anchor nodes linked by the connection are determined based on the function. In other words, the function for a particular connection is configured, which may be a function to be tested by the neural network for example, and the dimensions of the two anchor nodes linked by the connection may be determined in the manner as noted above while also taking into consideration the function. Configuring the dimensions of the two connected anchor nodes based on the function allows the method 100 to focus on exercising direct transformations between two similar anchor nodes.

To this end, a portion of a neural network is generated, using the set of linear equations. In one embodiment, the portion of a neural network may be represented by a directed graph, as shown by example in the embodiments below. In one embodiment, a sub-portion of the neural network may further be generated according to the one or more embodiments described above. In one embodiment, the sub-portion may be represented by a directed sub-graph of the directed graph. Accordingly, multiple portions of the neural network, which may or may not be nested, may be generated through multiple iterations of the method 100.

As noted above with respect to operation 104, the portion of the neural network is generated, based, at least in part, on whether the portion of the neural network is to produce a valid result, wherein the valid result includes a functional portion of the neural network. In one embodiment, the portion of the neural network produces a valid result when a connection therein does not produce a zero value, a negative value, or an infinite value, or when the portion otherwise provides a functional (i.e. stable, executable, etc.) portion of the neural network. The valid result may be produced by correctly determining the anchor node volumes from the set of linear equations, and further configuring the function for each connection such that the function correctly transforms the dimensions of the source anchor node to the dimensions of the destination anchor.

In one embodiment, one or more parameters to be used in conjunction with one or more linear equations are received, and one or more portions of a neural network are generated based, at least in part, on whether the one or more parameters is to cause the one or more portions of the neural network to produce a valid result. The one or more parameters may be the coefficients for the one or more linear equations. In one embodiment, the one or more parameters may be received in a matrix. In one embodiment, the one or more portions of the neural network are generated using the one or more parameters. In one embodiment, the one or more portions of the neural network are generated using the one or more linear equations, where the one or more linear equations are generated from the one or more parameters.

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

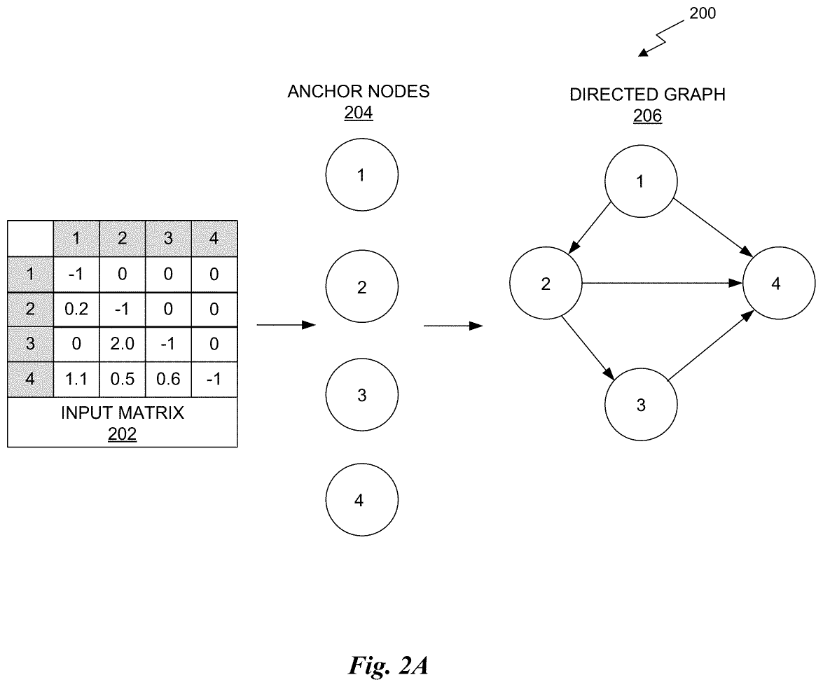

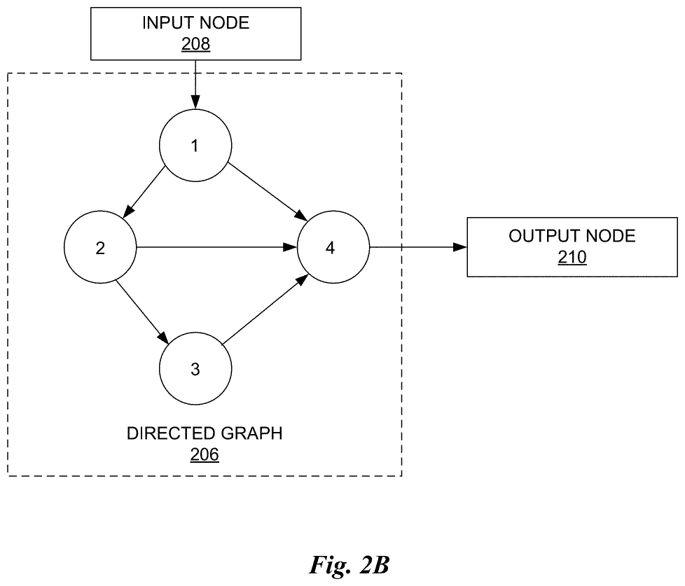

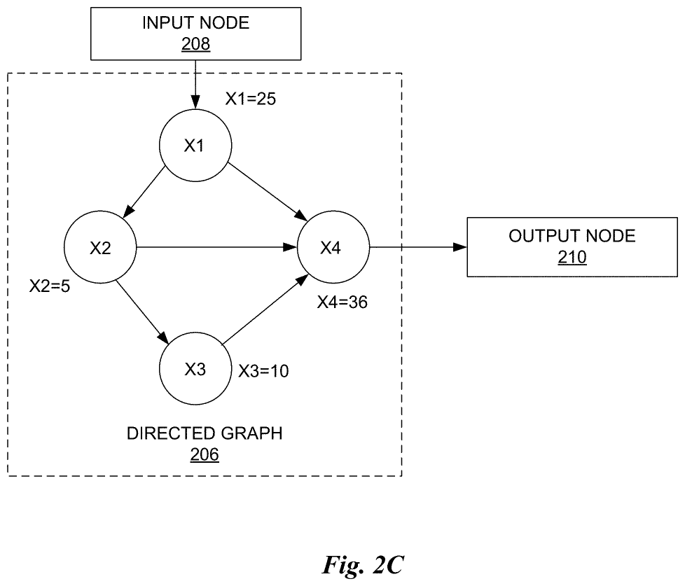

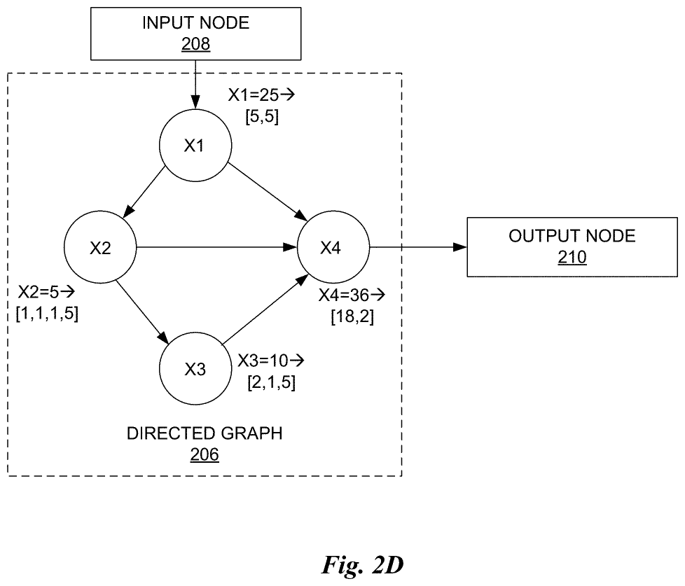

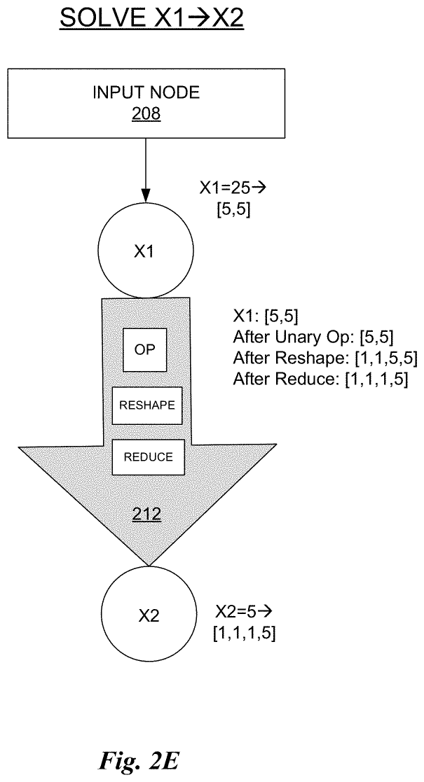

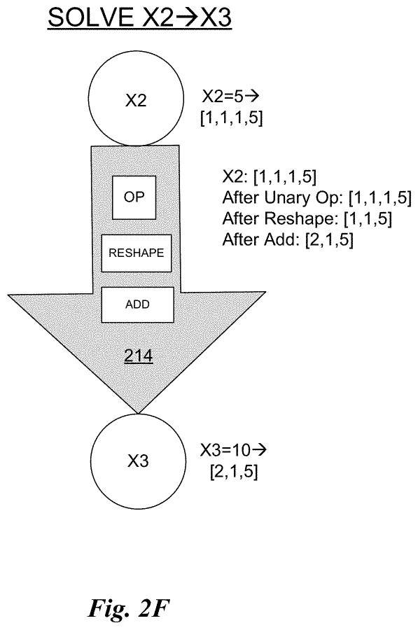

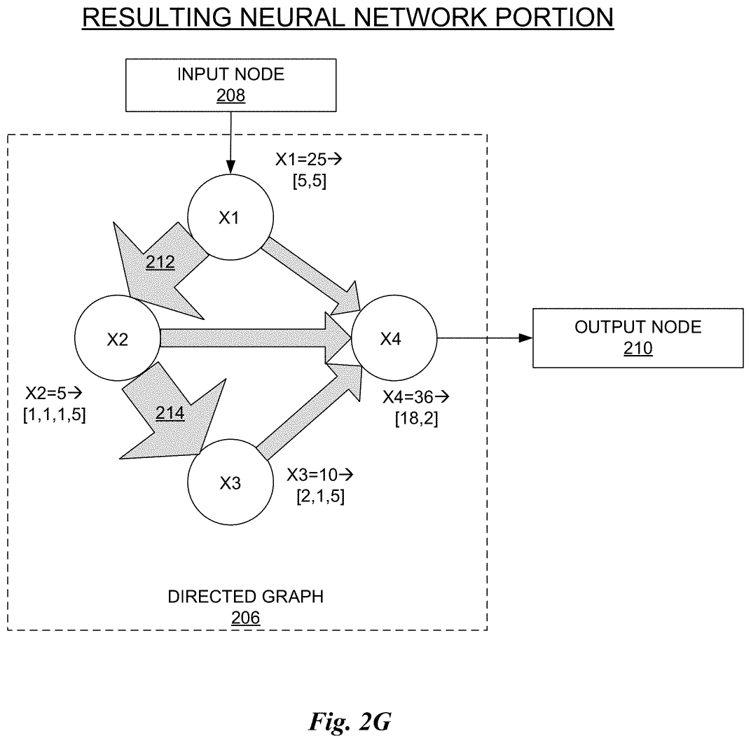

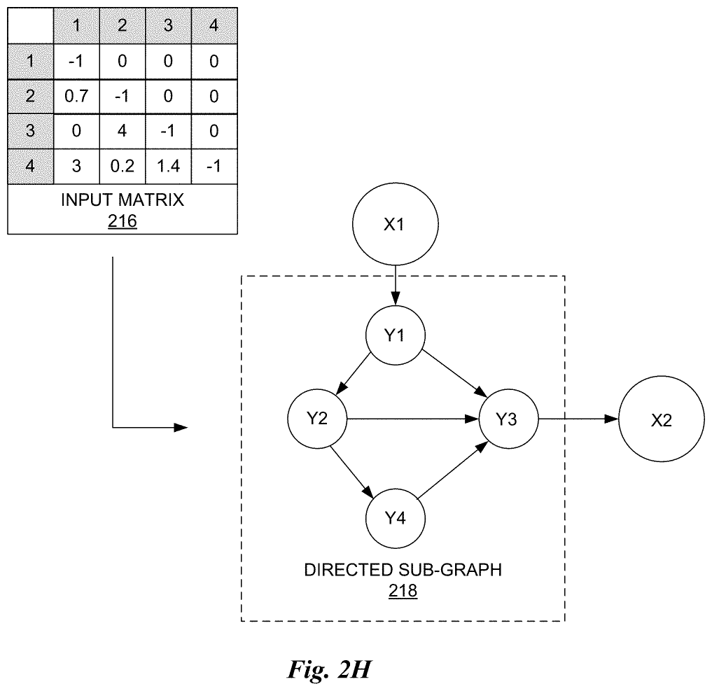

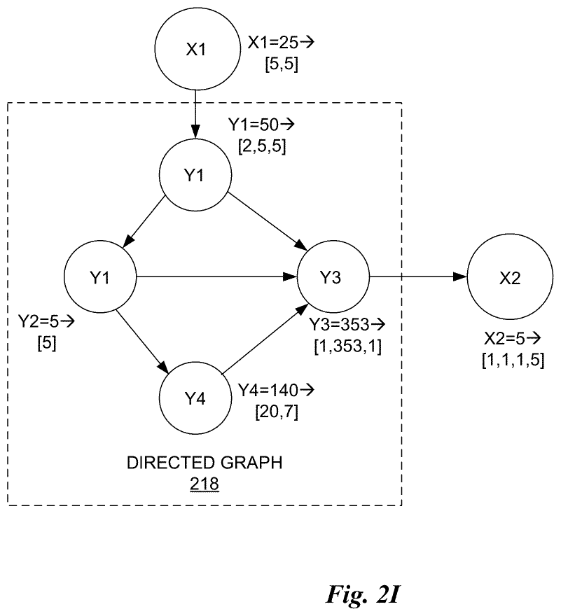

FIG. 2A illustrates a diagram of a directed graph representation of a portion of a neural network constructed from a matrix, in accordance with one embodiment. As an option, the definitions, descriptions, etc. provided with respect to FIG. 1 above may equally apply to the present description.

As shown, an input matrix 202 is provided for generating the portion of the neural network. The input matrix 202 dimensions define the number of the anchor nodes 204 in the portion, which is 4 in the embodiment shown (represented as 1, 2, 3, and 4). The non-zero values in the bottom left triangle of the input matrix 202 define the connections between the anchor nodes 204.

Thus, a directed graph 206, as shown, can be generated using the input matrix 202, namely based on the number of the anchor nodes 204 and the connections therebetween defined by the input matrix 202. In the embodiment shown, the inputs to the directed graph 206 are the (−1) diagonal entries with all row values equal to zero (0), and the outputs to the directed graph 206 are the (−1) diagonal entries with all column values equal to zero (0).

FIG. 2B illustrates the directed graph representation of FIG. 2A with input and output nodes connected to the portion of the neural network, in accordance with one embodiment.

As shown, the input node 208 represents input to the portion of the neural network represented by the directed graph 206, and in the embodiment shown provides input to anchor node 1. The input node 208 may be an input tensor, in one embodiment. The input node 208 may include user data, in one embodiment. The input node 208 may represent a volume of anchor node 1, in one embodiment.

The output node 210 represents output from the portion of the neural network represented by the directed graph 206, and in the embodiment shown receives output from anchor node 4. The output node 210 may be an output tensor, in one embodiment. The output node 210 may include user data, in one embodiment. The output node 210 may represent a volume of anchor node 4, in one embodiment.

Using the input matrix 202, a volume of each of the anchor nodes in the directed graph 206 is determined. FIG. 2C illustrates the directed graph representation of FIG. 2B with an indication of calculated node volumes, in accordance with one embodiment.

In one embodiment, the anchor node volumes may be calculated using an equation that is based on a position of the anchor node in the intermediate layer. Intermediate layer, as represented in directed graph 206, has input nodes 1 . . . l, intermediate nodes l+1 . . . m, and output nodes m+1 . . . n. Each node has an integer volume xᵢ related as follows:

Intermediate volumes are functions of inputs and previous intermediates, using Equation 1:

$${x}_{i} = {\sum }_{j = 1}^{i - 1} {r}_{ij} {x}_{j} \qquad ( Equation 1 )$$

Output volumes are a function of inputs and all intermediates, using Equation 2:

$${x}_{i} = {\sum }_{j = 1}^{m} {r}_{ij} {x}_{j} \qquad ( Equation 2 )$$

Integer solutions to these equations are determined in the case where the coefficients rₜⱼ are rational. This system is unit lower triangular, and remains so if the intermediates are eliminated to reduce to Equation 3:

$${x}_{i} = {\sum }_{j = 1}^{l} {r}_{ij}^{′} {x}_{j} \qquad ( Equation 3 )$$

The equations will have integral solutions if each r′ᵢⱼxⱼ is an integer, which is guaranteed if each input xⱼ is a multiple of the least common multiple of the divisors of its coefficients r′ᵢⱼ.

In an exemplary implementation of Equations 1-3 above, the node volumes may be calculated in accordance with the following description relating to Tables 1-4, in one embodiment.

In one embodiment, using the input matrix 202, the set of linear equations shown in Table 1 is generated. In particular, each linear equation is generated from a row in the input matrix 202, where each column corresponds to an anchor node in the intermediate layer and where each column value in the row is the coefficient for the corresponding anchor node. The first linear equation in the set is configured to be equal to the (−inputSize), and the remaining linear equations in the set are configured to be equal to zero. X1, X2, X3, and X4 correspond to anchor nodes 1, 2, 3, 4 in directed graph 206, respectively. The −inputSize represents the negative of a volume for an input anchor node of the anchor nodes, which in this case is X1 (with the inputSize for X1 to be selected).

TABLE 1

−1*X1 + 0*X2 + 0*X3 + 0*X4 = −inputSize
0.2*X1 + −1*X2 + 0*X3 + 0*X4 = 0
0*X1 + 2.0*X2 + −1*X3 + 0*X4 = 0
1.1*X1 + 0.5*X2 + 0.6*X3 + −1*X4 = 0

Next, the linear equations in the set are reduced, to represent a volume of a respective anchor node as a function of an input one of the anchor nodes (e.g. some coefficient value multiplied by the volume of the input anchor node). In this embodiment shown, the input anchor node is X1 (since X1 is an input node as shown in the directed graph 206), such that a volume of anchor nodes X2, X3, and X4 are represented in the reduced linear equations as a function of a volume of X1. Table 2 illustrates the reduced linear equations.

TABLE 2

X2 = 0.2*X1
X3 = 0.4*X1
X4 = 1.1*X1 + 0.1*X1 + 0.24*X1 = 1.44*X1

From the reduced linear equations, integer scale factors are determined for the anchor nodes, where the integer scale factors transform the coefficients in Table 2 into integers. Table 3 illustrates the integer scale factors determined from the reduced linear equations from Table 2.

TABLE 3

X2 needs integer scale factor 5 to convert .2 to 1
X3 needs integer scale factor 5 to convert .4 to 2
X4 needs integer scale factor 25 to convert 1.44 to 36

The least common multiple of the integer scale factors is then determined to be the minimum valid volume for the input anchor node X1. “Valid” refers to the volume for X1, which when selected, will produce integers for the volumes of the remaining anchor nodes. Thus, the intermediate layer for neural network, in this embodiment, will function based on integer node values.

From the least common multiple, volumes for each of the anchor nodes are determined using the reduced linear equations. Table 4 illustrates the volumes selected for the anchor nodes, based on the minimum valid input volume determined for X1.

TABLE 4

Let X1 = 25, then
X2 = 5,
X3 = 10, and
X4 = 36

Based on the anchor node volumes calculated for each of the anchor nodes, dimensions for each of the anchor nodes is determined. FIG. 2D illustrates the directed graph representation of FIG. 2C with an indication of determined node dimensions, in accordance with one embodiment.

In one embodiment, the dimensions for an anchor node correspond directly to the volume of the anchor node and may represent a shape of the anchor node. The number of dimensions and the dimension values for each anchor node may be determined, or selected, using a computer program. In one embodiment, the number of dimensions and/or the dimension values may be constrained within a predetermined range.

After the anchor node volumes and dimensions are determined, a function for each connection in the intermediate layer is determined. The function may be determined, or selected, using a computer program that combines one or more of the operations as described above.

FIG. 2E illustrates a function for the connection between node X1 and node X2 in the directed graph representation of FIG. 2D, in accordance with one embodiment.

As shown, the connection 212 between X1 and X2 includes a function comprised of a plurality of operations that transform the dimensions of X1 to the dimensions of X2. In the embodiment shown, the function includes a unary operation (e.g. that may be used as a test operation, in one embodiment). The unary operation, as shown, does not change the dimensions input from X1. Thus, the output from the unary operation is the same as the dimensions of X1: [5,5].

Following the unary operation is a reshape operation that changes the number of dimensions of the output from the unary operation. The reshape operation, as shown, changes the number of dimensions by adding two new dimensions, in order to match the number of dimensions of X2. As shown, the output from the reshape operation is [1,1,5,5]. The dimension values for the new dimensions may be selected to match the corresponding dimension values of X2.

Following the reshape operation is a reduce operation that reduces dimension values of the output of the reshape operation. The reduce operation, as shown, reduces the third dimension from “5” to “1”, in order to match the third dimension of X2. Thus, the output of the reduce operation, and thus the output of the function for the connection 212, matches the dimensions of X2.

The operations may include one or more operations to be tested using the neural network, one or more reshape operations that changes the number of dimensions of the input, one or more reduce operations that reduces dimension values (e.g. subtracts some amount from one or more of the dimension values), and/or one or more add operations that adds dimension values to (e.g. adds some amount to one or more of the dimension values).

FIG. 2F illustrates a function for the connection between node X2 and node X3 in the directed graph representation of FIG. 2D, in accordance with one embodiment.

As shown, the connection 214 between X2 and X3 includes a function comprised of a plurality of operations that transform the dimensions of X2 to the dimensions of X3. In the embodiment shown, the function includes a unary operation (e.g. that may be used as a test operation, in one embodiment). The unary operation, as shown, does not change the dimensions input from X2. Thus, the output from the unary operation is the same as the dimensions of X2: [1,1,1,5].

Following the unary operation is a reshape operation that changes the number of dimensions of the output from the unary operation. The reshape operation, as shown, changes the number of dimensions by removing the first dimension, in order to match the number of dimensions of X3. As shown, the output from the reshape operation is [1,1,5].

Following the reshape operation is an add operation that adds dimension values to the output of the reshape operation. The add operation, as shown, adds to the first dimension to change the first dimension from “1” to “2”, in order to match the first dimension of X3. Thus, the output of the add operation, and thus the output of the function for the connection 214, matches the dimensions of X3.

FIG. 2G illustrates an exemplary neural network portion resulting, in part, from the function in FIG. 2E and the function in FIG. 2F, in accordance with one embodiment. While not described herein, it should be noted that functions for the remaining connections may be determined in a manner similar to that described above for FIGS. 2E and 2F.

As an option, a sub-portion of the neural network may be generated for the portion represented by the directed graph 206 of FIG. 2G. The sub-portion is generated between connected anchor nodes of the already generated portion, and may be generated using the flow described above with respect to FIGS. 2A-2G. In particular, the sub-portion may be generated using a corresponding input matrix 216 determined for the sub-portion. Further, the sub-portion may be connected between connected anchor nodes by selecting functions to connect the portion to the sub-portion.

FIG. 2H illustrates a directed graph representation of a sub-portion of the intermediate layer of the neural network of FIG. 2G constructed from a matrix, in accordance with one embodiment.

In the embodiment shown, an input matrix 216 is determined for a sub-portion that is to be generated between X1 and X2. Based on the input matrix 216, a directed graph 218 is determined. The directed graph 218 includes the anchor nodes for the sub-portion (Y1, Y2, Y3, Y4) as well as the connections between those anchor nodes.

In the manner described above with respect to FIGS. 2C-2D, anchor node volumes and dimensions are determined for the anchor nodes in the directed graph 218. FIG. 2I illustrates the directed graph representation of FIG. 2H with an indication of calculated node volumes and determined node dimensions, in accordance with one embodiment. Further, while not shown, functions are determined for each connection in the sub-portion, as described above with respect to FIGS. 2E-2F, as well as functions to connect the sub-portion to X1 and X2. To this end, the flow illustrated through FIGS. 2A-2G may be repeated for different portions of the neural network, which may or may not be nested layers.

### Parallel Processing Architecture

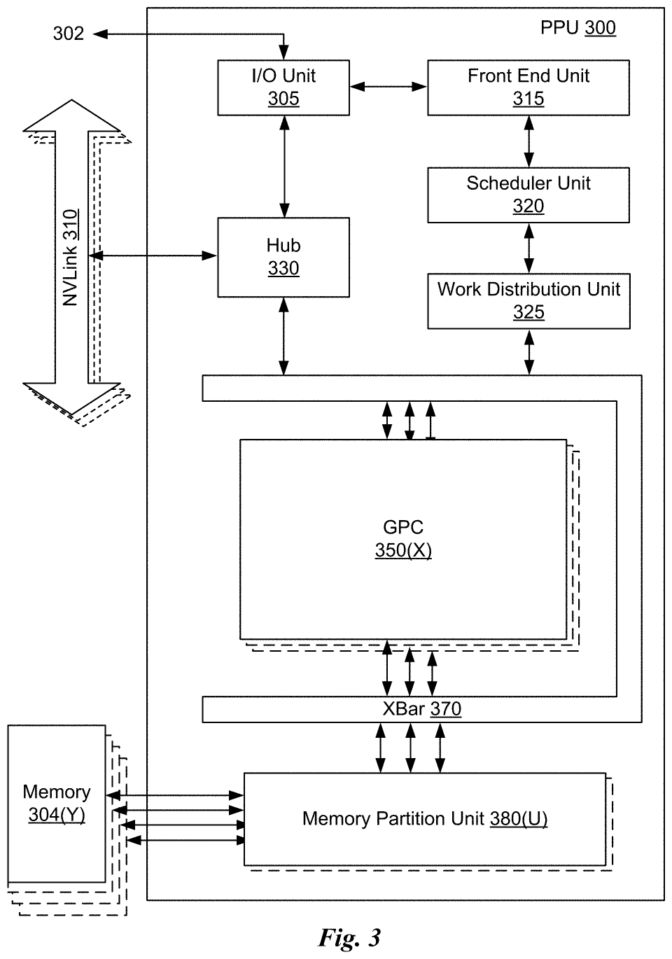

FIG. 3 illustrates a parallel processing unit (PPU) 300, in accordance with an embodiment. In an embodiment, the PPU 300 is a multi-threaded processor that is implemented on one or more integrated circuit devices. The PPU 300 is a latency hiding architecture designed to process many threads in parallel. A thread (e.g., a thread of execution) is an instantiation of a set of instructions configured to be executed by the PPU 300. In an embodiment, the PPU 300 is a graphics processing unit (GPU) configured to implement a graphics rendering pipeline for processing three-dimensional (3D) graphics data in order to generate two-dimensional (2D) image data for display on a display device such as a liquid crystal display (LCD) device. In other embodiments, the PPU 300 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more PPUs 300 may be configured to accelerate thousands of High Performance Computing (HPC), data center, and machine learning applications. The PPU 300 may be configured to accelerate numerous deep learning systems and applications including autonomous vehicle platforms, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 3, the PPU 300 includes an Input/Output (I/O) unit 305, a front end unit 315, a scheduler unit 320, a work distribution unit 325, a hub 330, a crossbar (Xbar) 370, one or more general processing clusters (GPCs) 350, and one or more memory partition units 380. The PPU 300 may be connected to a host processor or other PPUs 300 via one or more high-speed NVLink 310 interconnect. The PPU 300 may be connected to a host processor or other peripheral devices via an interconnect 302. The PPU 300 may also be connected to a local memory comprising a number of memory devices 304. In an embodiment, the local memory may comprise a number of dynamic random access memory (DRAM) devices. The DRAM devices may be configured as a high-bandwidth memory (HBM) subsystem, with multiple DRAM dies stacked within each device.

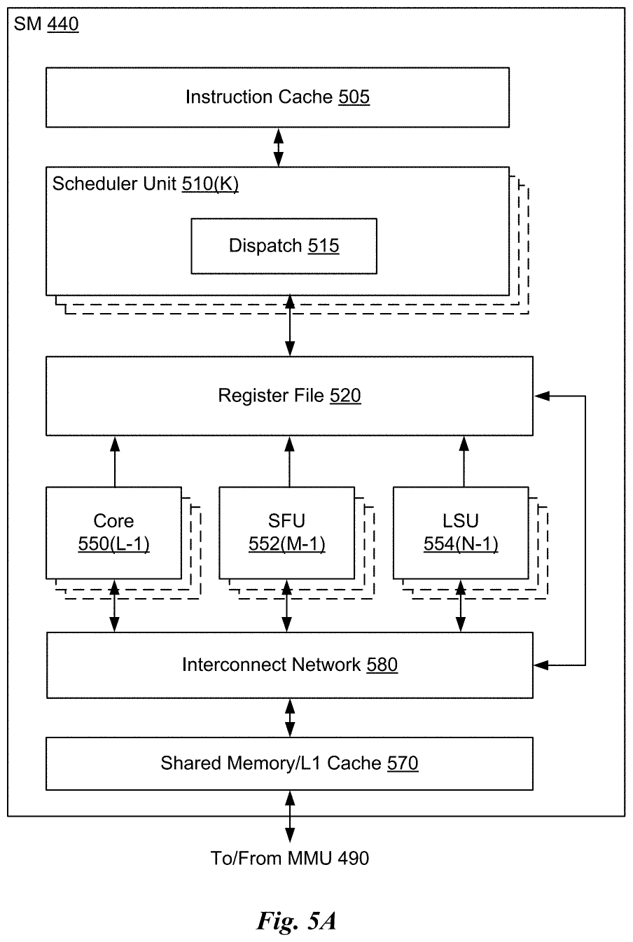

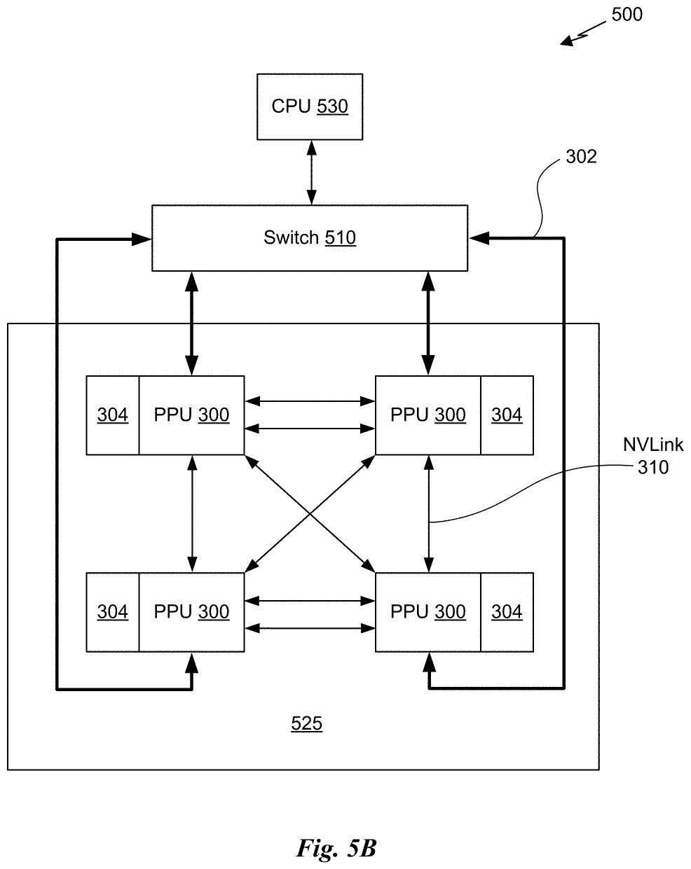

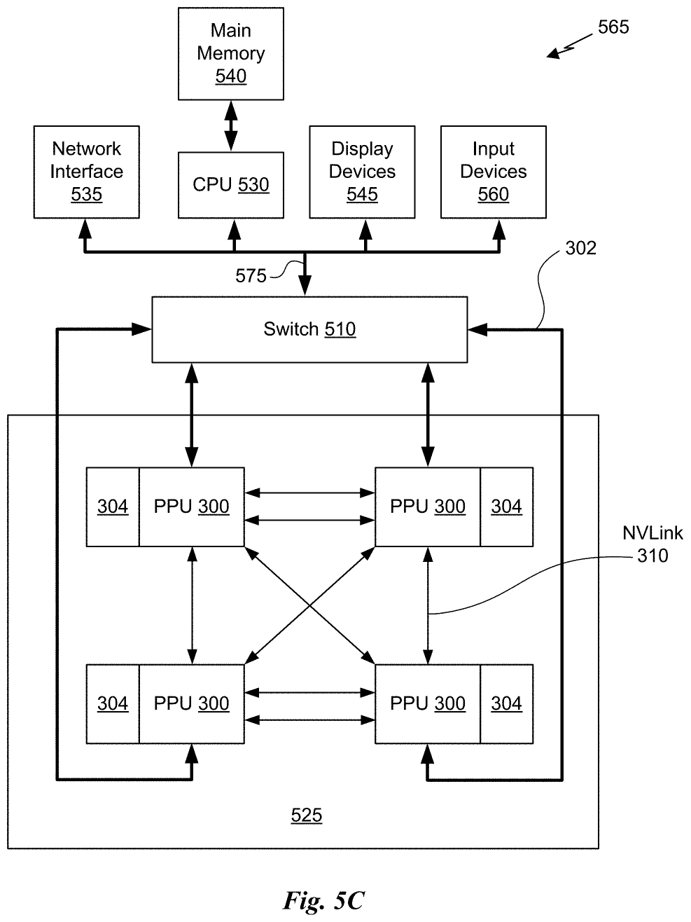

The NVLink 310 interconnect enables systems to scale and include one or more PPUs 300 combined with one or more CPUs, supports cache coherence between the PPUs 300 and CPUs, and CPU mastering. Data and/or commands may be transmitted by the NVLink 310 through the hub 330 to/from other units of the PPU 300 such as one or more copy engines, a video encoder, a video decoder, a power management unit, etc. (not explicitly shown). The NVLink 310 is described in more detail in conjunction with FIG. 5B.

The I/O unit 305 is configured to transmit and receive communications (e.g., commands, data, etc.) from a host processor (not shown) over the interconnect 302. The I/O unit 305 may communicate with the host processor directly via the interconnect 302 or through one or more intermediate devices such as a memory bridge. In an embodiment, the I/O unit 305 may communicate with one or more other processors, such as one or more the PPUs 300 via the interconnect 302. In an embodiment, the I/O unit 305 implements a Peripheral Component Interconnect Express (PCIe) interface for communications over a PCIe bus and the interconnect 302 is a PCIe bus. In alternative embodiments, the I/O unit 305 may implement other types of well-known interfaces for communicating with external devices.

The I/O unit 305 decodes packets received via the interconnect 302. In an embodiment, the packets represent commands configured to cause the PPU 300 to perform various operations. The I/O unit 305 transmits the decoded commands to various other units of the PPU 300 as the commands may specify. For example, some commands may be transmitted to the front end unit 315. Other commands may be transmitted to the hub 330 or other units of the PPU 300 such as one or more copy engines, a video encoder, a video decoder, a power management unit, etc. (not explicitly shown). In other words, the I/O unit 305 is configured to route communications between and among the various logical units of the PPU 300.

In an embodiment, a program executed by the host processor encodes a command stream in a buffer that provides workloads to the PPU 300 for processing. A workload may comprise several instructions and data to be processed by those instructions. The buffer is a region in a memory that is accessible (e.g., read/write) by both the host processor and the PPU 300. For example, the I/O unit 305 may be configured to access the buffer in a system memory connected to the interconnect 302 via memory requests transmitted over the interconnect 302. In an embodiment, the host processor writes the command stream to the buffer and then transmits a pointer to the start of the command stream to the PPU 300. The front end unit 315 receives pointers to one or more command streams. The front end unit 315 manages the one or more streams, reading commands from the streams and forwarding commands to the various units of the PPU 300.

The front end unit 315 is coupled to a scheduler unit 320 that configures the various GPCs 350 to process tasks defined by the one or more streams. The scheduler unit 320 is configured to track state information related to the various tasks managed by the scheduler unit 320. The state may indicate which GPC 350 a task is assigned to, whether the task is active or inactive, a priority level associated with the task, and so forth. The scheduler unit 320 manages the execution of a plurality of tasks on the one or more GPCs 350.

The scheduler unit 320 is coupled to a work distribution unit 325 that is configured to dispatch tasks for execution on the GPCs 350. The work distribution unit 325 may track a number of scheduled tasks received from the scheduler unit 320. In an embodiment, the work distribution unit 325 manages a pending task pool and an active task pool for each of the GPCs 350. The pending task pool may comprise a number of slots (e.g., 32 slots) that contain tasks assigned to be processed by a particular GPC 350. The active task pool may comprise a number of slots (e.g., 4 slots) for tasks that are actively being processed by the GPCs 350. As a GPC 350 finishes the execution of a task, that task is evicted from the active task pool for the GPC 350 and one of the other tasks from the pending task pool is selected and scheduled for execution on the GPC 350. If an active task has been idle on the GPC 350, such as while waiting for a data dependency to be resolved, then the active task may be evicted from the GPC 350 and returned to the pending task pool while another task in the pending task pool is selected and scheduled for execution on the GPC 350.

The work distribution unit 325 communicates with the one or more GPCs 350 via XBar 370. The XBar 370 is an interconnect network that couples many of the units of the PPU 300 to other units of the PPU 300. For example, the XBar 370 may be configured to couple the work distribution unit 325 to a particular GPC 350. Although not shown explicitly, one or more other units of the PPU 300 may also be connected to the XBar 370 via the hub 330.

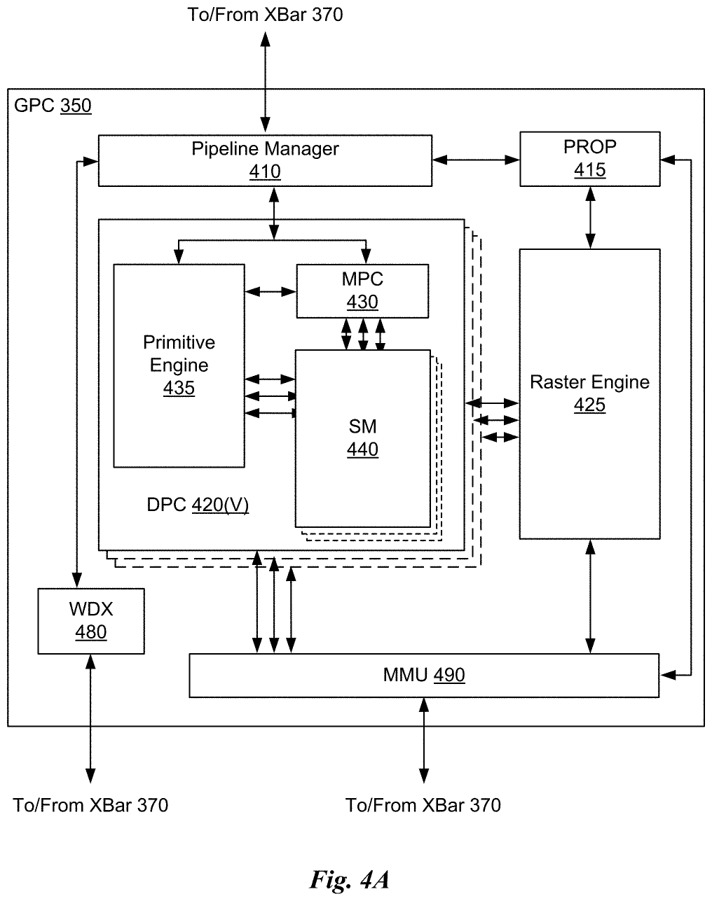

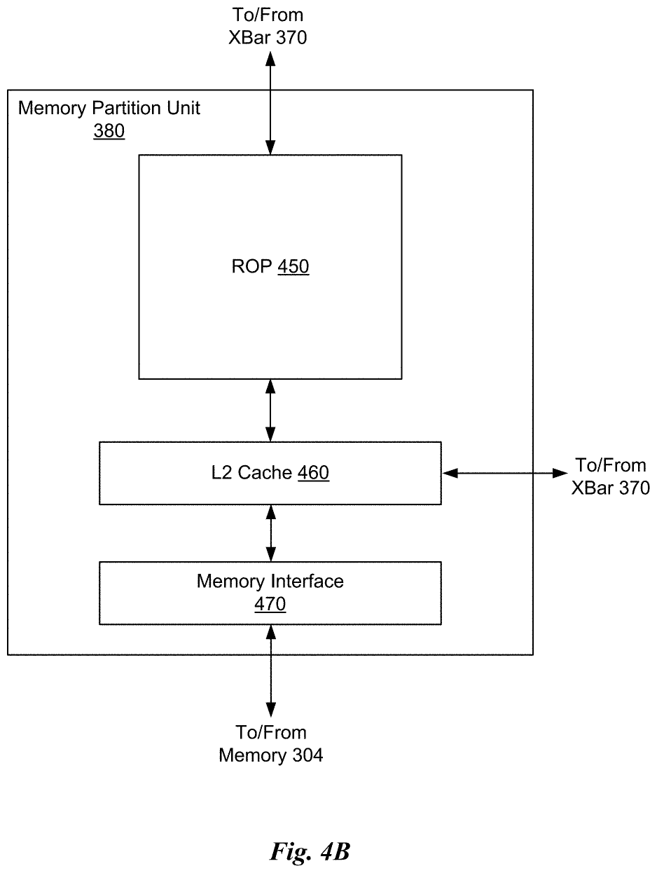

The tasks are managed by the scheduler unit 320 and dispatched to a GPC 350 by the work distribution unit 325. The GPC 350 is configured to process the task and generate results. The results may be consumed by other tasks within the GPC 350, routed to a different GPC 350 via the XBar 370, or stored in the memory 304. The results can be written to the memory 304 via the memory partition units 380, which implement a memory interface for reading and writing data to/from the memory 304. The results can be transmitted to another PPU 304 or CPU via the NVLink 310. In an embodiment, the PPU 300 includes a number U of memory partition units 380 that is equal to the number of separate and distinct memory devices 304 coupled to the PPU 300. A memory partition unit 380 will be described in more detail below in conjunction with FIG. 4B.

In an embodiment, a host processor executes a driver kernel that implements an application programming interface (API) that enables one or more applications executing on the host processor to schedule operations for execution on the PPU 300. In an embodiment, multiple compute applications are simultaneously executed by the PPU 300 and the PPU 300 provides isolation, quality of service (QoS), and independent address spaces for the multiple compute applications. An application may generate instructions (e.g., API calls) that cause the driver kernel to generate one or more tasks for execution by the PPU 300. The driver kernel outputs tasks to one or more streams being processed by the PPU 300. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. Threads and cooperating threads are described in more detail in conjunction with FIG. 5A.

FIG. 4A illustrates a GPC 350 of the PPU 300 of FIG. 3, in accordance with an embodiment. As shown in FIG. 4A, each GPC 350 includes a number of hardware units for processing tasks. In an embodiment, each GPC 350 includes a pipeline manager 410, a pre-raster operations unit (PROP) 415, a raster engine 425, a work distribution crossbar (WDX) 480, a memory management unit (MMU) 490, and one or more Data Processing Clusters (DPCs) 420. It will be appreciated that the GPC 350 of FIG. 4A may include other hardware units in lieu of or in addition to the units shown in FIG. 4A.

In an embodiment, the operation of the GPC 350 is controlled by the pipeline manager 410. The pipeline manager 410 manages the configuration of the one or more DPCs 420 for processing tasks allocated to the GPC 350. In an embodiment, the pipeline manager 410 may configure at least one of the one or more DPCs 420 to implement at least a portion of a graphics rendering pipeline. For example, a DPC 420 may be configured to execute a vertex shader program on the programmable streaming multiprocessor (SM) 440. The pipeline manager 410 may also be configured to route packets received from the work distribution unit 325 to the appropriate logical units within the GPC 350. For example, some packets may be routed to fixed function hardware units in the PROP 415 and/or raster engine 425 while other packets may be routed to the DPCs 420 for processing by the primitive engine 435 or the SM 440. In an embodiment, the pipeline manager 410 may configure at least one of the one or more DPCs 420 to implement a neural network model and/or a computing pipeline.

The PROP unit 415 is configured to route data generated by the raster engine 425 and the DPCs 420 to a Raster Operations (ROP) unit, described in more detail in conjunction with FIG. 4B. The PROP unit 415 may also be configured to perform optimizations for color blending, organize pixel data, perform address translations, and the like.

The raster engine 425 includes a number of fixed function hardware units configured to perform various raster operations. In an embodiment, the raster engine 425 includes a setup engine, a coarse raster engine, a culling engine, a clipping engine, a fine raster engine, and a tile coalescing engine. The setup engine receives transformed vertices and generates plane equations associated with the geometric primitive defined by the vertices. The plane equations are transmitted to the coarse raster engine to generate coverage information (e.g., an x,y coverage mask for a tile) for the primitive. The output of the coarse raster engine is transmitted to the culling engine where fragments associated with the primitive that fail a z-test are culled, and transmitted to a clipping engine where fragments lying outside a viewing frustum are clipped. Those fragments that survive clipping and culling may be passed to the fine raster engine to generate attributes for the pixel fragments based on the plane equations generated by the setup engine. The output of the raster engine 425 comprises fragments to be processed, for example, by a fragment shader implemented within a DPC 420.

Each DPC 420 included in the GPC 350 includes an M-Pipe Controller (MPC) 430, a primitive engine 435, and one or more SMs 440. The MPC 430 controls the operation of the DPC 420, routing packets received from the pipeline manager 410 to the appropriate units in the DPC 420. For example, packets associated with a vertex may be routed to the primitive engine 435, which is configured to fetch vertex attributes associated with the vertex from the memory 304. In contrast, packets associated with a shader program may be transmitted to the SM 440.

The SM 440 comprises a programmable streaming processor that is configured to process tasks represented by a number of threads. Each SM 440 is multi-threaded and configured to execute a plurality of threads (e.g., 32 threads) from a particular group of threads concurrently. In an embodiment, the SM 440 implements a SIMD (Single-Instruction, Multiple-Data) architecture where each thread in a group of threads (e.g., a warp) is configured to process a different set of data based on the same set of instructions. All threads in the group of threads execute the same instructions. In another embodiment, the SM 440 implements a SIMT (Single-Instruction, Multiple Thread) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency. The SM 440 will be described in more detail below in conjunction with FIG. 5A.

The MMU 490 provides an interface between the GPC 350 and the memory partition unit 380. The MMU 490 may provide translation of virtual addresses into physical addresses, memory protection, and arbitration of memory requests. In an embodiment, the MMU 490 provides one or more translation lookaside buffers (TLBs) for performing translation of virtual addresses into physical addresses in the memory 304.

FIG. 4B illustrates a memory partition unit 380 of the PPU 300 of FIG. 3, in accordance with an embodiment. As shown in FIG. 4B, the memory partition unit 380 includes a Raster Operations (ROP) unit 450, a level two (L2) cache 460, and a memory interface 470. The memory interface 470 is coupled to the memory 304. Memory interface 470 may implement 32, 64, 128, 1024-bit data buses, or the like, for high-speed data transfer. In an embodiment, the PPU 300 incorporates U memory interfaces 470, one memory interface 470 per pair of memory partition units 380, where each pair of memory partition units 380 is connected to a corresponding memory device 304. For example, PPU 300 may be connected to up to Y memory devices 304, such as high bandwidth memory stacks or graphics double-data-rate, version 5, synchronous dynamic random access memory, or other types of persistent storage.

In an embodiment, the memory interface 470 implements an HBM2 memory interface and Y equals half U. In an embodiment, the HBM2 memory stacks are located on the same physical package as the PPU 300, providing substantial power and area savings compared with conventional GDDR5 SDRAM systems. In an embodiment, each HBM2 stack includes four memory dies and Y equals 4, with HBM2 stack including two 128-bit channels per die for a total of 8 channels and a data bus width of 1024 bits.

In an embodiment, the memory 304 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where PPUs 300 process very large datasets and/or run applications for extended periods.

In an embodiment, the PPU 300 implements a multi-level memory hierarchy. In an embodiment, the memory partition unit 380 supports a unified memory to provide a single unified virtual address space for CPU and PPU 300 memory, enabling data sharing between virtual memory systems. In an embodiment the frequency of accesses by a PPU 300 to memory located on other processors is traced to ensure that memory pages are moved to the physical memory of the PPU 300 that is accessing the pages more frequently. In an embodiment, the NVLink 310 supports address translation services allowing the PPU 300 to directly access a CPU's page tables and providing full access to CPU memory by the PPU 300.

In an embodiment, copy engines transfer data between multiple PPUs 300 or between PPUs 300 and CPUs. The copy engines can generate page faults for addresses that are not mapped into the page tables. The memory partition unit 380 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 304 or other system memory may be fetched by the memory partition unit 380 and stored in the L2 cache 460, which is located on-chip and is shared between the various GPCs 350. As shown, each memory partition unit 380 includes a portion of the L2 cache 460 associated with a corresponding memory device 304. Lower level caches may then be implemented in various units within the GPCs 350. For example, each of the SMs 440 may implement a level one (L1) cache. The L1 cache is private memory that is dedicated to a particular SM 440. Data from the L2 cache 460 may be fetched and stored in each of the L1 caches for processing in the functional units of the SMs 440. The L2 cache 460 is coupled to the memory interface 470 and the XBar 370.

The ROP unit 450 performs graphics raster operations related to pixel color, such as color compression, pixel blending, and the like. The ROP unit 450 also implements depth testing in conjunction with the raster engine 425, receiving a depth for a sample location associated with a pixel fragment from the culling engine of the raster engine 425. The depth is tested against a corresponding depth in a depth buffer for a sample location associated with the fragment. If the fragment passes the depth test for the sample location, then the ROP unit 450 updates the depth buffer and transmits a result of the depth test to the raster engine 425. It will be appreciated that the number of memory partition units 380 may be different than the number of GPCs 350 and, therefore, each ROP unit 450 may be coupled to each of the GPCs 350. The ROP unit 450 tracks packets received from the different GPCs 350 and determines which GPC 350 that a result generated by the ROP unit 450 is routed to through the Xbar 370. Although the ROP unit 450 is included within the memory partition unit 380 in FIG. 4B, in other embodiment, the ROP unit 450 may be outside of the memory partition unit 380. For example, the ROP unit 450 may reside in the GPC 350 or another unit.

FIG. 5A illustrates the streaming multi-processor 440 of FIG. 4A, in accordance with an embodiment. As shown in FIG. 5A, the SM 440 includes an instruction cache 505, one or more scheduler units 510, a register file 520, one or more processing cores 550, one or more special function units (SFUs) 552, one or more load/store units (LSUs) 554, an interconnect network 580, a shared memory/L1 cache 570.

As described above, the work distribution unit 325 dispatches tasks for execution on the GPCs 350 of the PPU 300. The tasks are allocated to a particular DPC 420 within a GPC 350 and, if the task is associated with a shader program, the task may be allocated to an SM 440. The scheduler unit 510 receives the tasks from the work distribution unit 325 and manages instruction scheduling for one or more thread blocks assigned to the SM 440. The scheduler unit 510 schedules thread blocks for execution as warps of parallel threads, where each thread block is allocated at least one warp. In an embodiment, each warp executes 32 threads. The scheduler unit 510 may manage a plurality of different thread blocks, allocating the warps to the different thread blocks and then dispatching instructions from the plurality of different cooperative groups to the various functional units (e.g., cores 550, SFUs 552, and LSUs 554) during each clock cycle.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

A dispatch unit 515 is configured to transmit instructions to one or more of the functional units. In the embodiment, the scheduler unit 510 includes two dispatch units 515 that enable two different instructions from the same warp to be dispatched during each clock cycle. In alternative embodiments, each scheduler unit 510 may include a single dispatch unit 515 or additional dispatch units 515.

Each SM 440 includes a register file 520 that provides a set of registers for the functional units of the SM 440. In an embodiment, the register file 520 is divided between each of the functional units such that each functional unit is allocated a dedicated portion of the register file 520. In another embodiment, the register file 520 is divided between the different warps being executed by the SM 440. The register file 520 provides temporary storage for operands connected to the data paths of the functional units.

Each SM 440 comprises L processing cores 550. In an embodiment, the SM 440 includes a large number (e.g., 128, etc.) of distinct processing cores 550. Each core 550 may include a fully-pipelined, single-precision, double-precision, and/or mixed precision processing unit that includes a floating point arithmetic logic unit and an integer arithmetic logic unit. In an embodiment, the floating point arithmetic logic units implement the IEEE 754-2008 standard for floating point arithmetic. In an embodiment, the cores 550 include 64 single-precision (32-bit) floating point cores, 64 integer cores, 32 double-precision (64-bit) floating point cores, and 8 tensor cores.

Tensor cores configured to perform matrix operations, and, in an embodiment, one or more tensor cores are included in the cores 550. In particular, the tensor cores are configured to perform deep learning matrix arithmetic, such as convolution operations for neural network training and inferencing. In an embodiment, each tensor core operates on a 4×4 matrix and performs a matrix multiply and accumulate operation D=A×B+C, where A, B, C, and D are 4×4 matrices.

In an embodiment, the matrix multiply inputs A and B are 16-bit floating point matrices, while the accumulation matrices C and D may be 16-bit floating point or 32-bit floating point matrices. Tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each SM 440 also comprises M SFUs 552 that perform special functions (e.g., attribute evaluation, reciprocal square root, and the like). In an embodiment, the SFUs 552 may include a tree traversal unit configured to traverse a hierarchical tree data structure. In an embodiment, the SFUs 552 may include texture unit configured to perform texture map filtering operations. In an embodiment, the texture units are configured to load texture maps (e.g., a 2D array of texels) from the memory 304 and sample the texture maps to produce sampled texture values for use in shader programs executed by the SM 440. In an embodiment, the texture maps are stored in the shared memory/L1 cache 470. The texture units implement texture operations such as filtering operations using mip-maps (e.g., texture maps of varying levels of detail). In an embodiment, each SM 340 includes two texture units.

Each SM 440 also comprises N LSUs 554 that implement load and store operations between the shared memory/L1 cache 570 and the register file 520. Each SM 440 includes an interconnect network 580 that connects each of the functional units to the register file 520 and the LSU 554 to the register file 520, shared memory/L1 cache 570. In an embodiment, the interconnect network 580 is a crossbar that can be configured to connect any of the functional units to any of the registers in the register file 520 and connect the LSUs 554 to the register file and memory locations in shared memory/L1 cache 570.

The shared memory/L1 cache 570 is an array of on-chip memory that allows for data storage and communication between the SM 440 and the primitive engine 435 and between threads in the SM 440. In an embodiment, the shared memory/L1 cache 570 comprises 128 KB of storage capacity and is in the path from the SM 440 to the memory partition unit 380. The shared memory/L1 cache 570 can be used to cache reads and writes. One or more of the shared memory/L1 cache 570, L2 cache 460, and memory 304 are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory/L1 cache 570 enables the shared memory/L1 cache 570 to function as a high-throughput conduit for streaming data while simultaneously providing high-bandwidth and low-latency access to frequently reused data.

When configured for general purpose parallel computation, a simpler configuration can be used compared with graphics processing. Specifically, the fixed function graphics processing units shown in FIG. 3, are bypassed, creating a much simpler programming model. In the general purpose parallel computation configuration, the work distribution unit 325 assigns and distributes blocks of threads directly to the DPCs 420. The threads in a block execute the same program, using a unique thread ID in the calculation to ensure each thread generates unique results, using the SM 440 to execute the program and perform calculations, shared memory/L1 cache 570 to communicate between threads, and the LSU 554 to read and write global memory through the shared memory/L1 cache 570 and the memory partition unit 380. When configured for general purpose parallel computation, the SM 440 can also write commands that the scheduler unit 320 can use to launch new work on the DPCs 420.

The PPU 300 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the PPU 300 is embodied on a single semiconductor substrate. In another embodiment, the PPU 300 is included in a system-on-a-chip (SoC) along with one or more other devices such as additional PPUs 300, the memory 304, a reduced instruction set computer (RISC) CPU, a memory management unit (MMU), a digital-to-analog converter (DAC), and the like.

In an embodiment, the PPU 300 may be included on a graphics card that includes one or more memory devices 304. The graphics card may be configured to interface with a PCIe slot on a motherboard of a desktop computer. In yet another embodiment, the PPU 300 may be an integrated graphics processing unit (iGPU) or parallel processor included in the chipset of the motherboard.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 5B is a conceptual diagram of a processing system 500 implemented using the PPU 300 of FIG. 3, in accordance with an embodiment. The exemplary system 565 may be configured to implement the method 100 shown in FIG. 1. The processing system 500 includes a CPU 530, switch 510, and multiple PPUs 300 each and respective memories 304. The NVLink 310 provides high-speed communication links between each of the PPUs 300. Although a particular number of NVLink 310 and interconnect 302 connections are illustrated in FIG. 5B, the number of connections to each PPU 300 and the CPU 530 may vary. The switch 510 interfaces between the interconnect 302 and the CPU 530. The PPUs 300, memories 304, and NVLinks 310 may be situated on a single semiconductor platform to form a parallel processing module 525. In an embodiment, the switch 510 supports two or more protocols to interface between various different connections and/or links.

In another embodiment (not shown), the NVLink 310 provides one or more high-speed communication links between each of the PPUs 300 and the CPU 530 and the switch 510 interfaces between the interconnect 302 and each of the PPUs 300. The PPUs 300, memories 304, and interconnect 302 may be situated on a single semiconductor platform to form a parallel processing module 525. In yet another embodiment (not shown), the interconnect 302 provides one or more communication links between each of the PPUs 300 and the CPU 530 and the switch 510 interfaces between each of the PPUs 300 using the NVLink 310 to provide one or more high-speed communication links between the PPUs 300. In another embodiment (not shown), the NVLink 310 provides one or more high-speed communication links between the PPUs 300 and the CPU 530 through the switch 510. In yet another embodiment (not shown), the interconnect 302 provides one or more communication links between each of the PPUs 300 directly. One or more of the NVLink 310 high-speed communication links may be implemented as a physical NVLink interconnect or either an on-chip or on-die interconnect using the same protocol as the NVLink 310.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 525 may be implemented as a circuit board substrate and each of the PPUs 300 and/or memories 304 may be packaged devices. In an embodiment, the CPU 530, switch 510, and the parallel processing module 525 are situated on a single semiconductor platform.

In an embodiment, the signaling rate of each NVLink 310 is 20 to 25 Gigabits/second and each PPU 300 includes six NVLink 310 interfaces (as shown in FIG. 5B, five NVLink 310 interfaces are included for each PPU 300). Each NVLink 310 provides a data transfer rate of 25 Gigabytes/second in each direction, with six links providing 300 Gigabytes/second. The NVLinks 310 can be used exclusively for PPU-to-PPU communication as shown in FIG. 5B, or some combination of PPU-to-PPU and PPU-to-CPU, when the CPU 530 also includes one or more NVLink 310 interfaces.

In an embodiment, the NVLink 310 allows direct load/store/atomic access from the CPU 530 to each PPU's 300 memory 304. In an embodiment, the NVLink 310 supports coherency operations, allowing data read from the memories 304 to be stored in the cache hierarchy of the CPU 530, reducing cache access latency for the CPU 530. In an embodiment, the NVLink 310 includes support for Address Translation Services (ATS), allowing the PPU 300 to directly access page tables within the CPU 530. One or more of the NVLinks 310 may also be configured to operate in a low-power mode.

FIG. 5C illustrates an exemplary system 565 in which the various architecture and/or functionality of the various previous embodiments may be implemented. The exemplary system 565 may be configured to implement the method 100 shown in FIG. 1.

As shown, a system 565 is provided including at least one central processing unit 530 that is connected to a communication bus 575. The communication bus 575 may be implemented using any suitable protocol, such as PCI (Peripheral Component Interconnect), PCI-Express, AGP (Accelerated Graphics Port), HyperTransport, or any other bus or point-to-point communication protocol(s). The system 565 also includes a main memory 540. Control logic (software) and data are stored in the main memory 540 which may take the form of random access memory (RAM).

The system 565 also includes input devices 560, the parallel processing system 525, and display devices 545, e.g. a conventional CRT (cathode ray tube), LCD (liquid crystal display), LED (light emitting diode), plasma display or the like. User input may be received from the input devices 560, e.g., keyboard, mouse, touchpad, microphone, and the like. Each of the foregoing modules and/or devices may even be situated on a single semiconductor platform to form the system 565. Alternately, the various modules may also be situated separately or in various combinations of semiconductor platforms per the desires of the user.

Further, the system 565 may be coupled to a network (e.g., a telecommunications network, local area network (LAN), wireless network, wide area network (WAN) such as the Internet, peer-to-peer network, cable network, or the like) through a network interface 535 for communication purposes.

The system 565 may also include a secondary storage (not shown). The secondary storage 610 includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 540 and/or the secondary storage. Such computer programs, when executed, enable the system 565 to perform various functions. The memory 540, the storage, and/or any other storage are possible examples of computer-readable media.

The architecture and/or functionality of the various previous figures may be implemented in the context of a general computer system, a circuit board system, a game console system dedicated for entertainment purposes, an application-specific system, and/or any other desired system. For example, the system 565 may take the form of a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, a mobile phone device, a television, workstation, game consoles, embedded system, and/or any other type of logic.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### Graphics Processing Pipeline

In an embodiment, the PPU 300 comprises a graphics processing unit (GPU). The PPU 300 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The PPU 300 can be configured to process the graphics primitives to generate a frame buffer (e.g., pixel data for each of the pixels of the display).

An application writes model data for a scene (e.g., a collection of vertices and attributes) to a memory such as a system memory or memory 304. The model data defines each of the objects that may be visible on a display. The application then makes an API call to the driver kernel that requests the model data to be rendered and displayed. The driver kernel reads the model data and writes commands to the one or more streams to perform operations to process the model data. The commands may reference different shader programs to be implemented on the SMs 440 of the PPU 300 including one or more of a vertex shader, hull shader, domain shader, geometry shader, and a pixel shader. For example, one or more of the SMs 440 may be configured to execute a vertex shader program that processes a number of vertices defined by the model data. In an embodiment, the different SMs 440 may be configured to execute different shader programs concurrently. For example, a first subset of SMs 440 may be configured to execute a vertex shader program while a second subset of SMs 440 may be configured to execute a pixel shader program. The first subset of SMs 440 processes vertex data to produce processed vertex data and writes the processed vertex data to the L2 cache 460 and/or the memory 304. After the processed vertex data is rasterized (e.g., transformed from three-dimensional data into two-dimensional data in screen space) to produce fragment data, the second subset of SMs 440 executes a pixel shader to produce processed fragment data, which is then blended with other processed fragment data and written to the frame buffer in memory 304. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

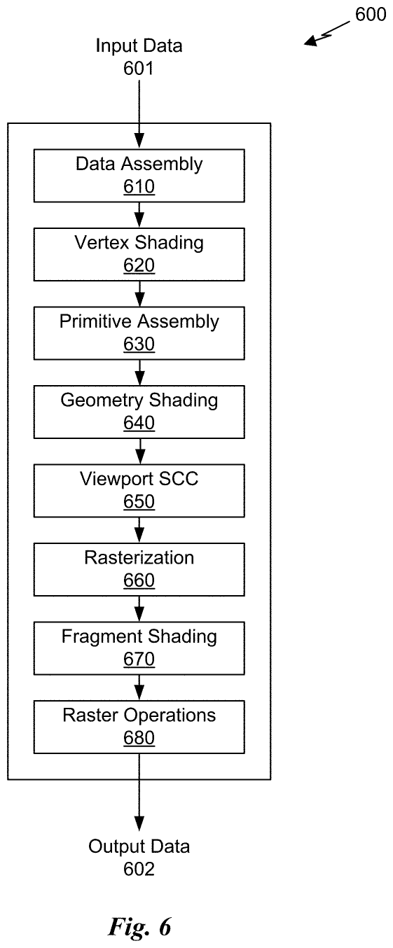

FIG. 6 is a conceptual diagram of a graphics processing pipeline 600 implemented by the PPU 300 of FIG. 3, in accordance with an embodiment. The graphics processing pipeline 600 is an abstract flow diagram of the processing steps implemented to generate 2D computer-generated images from 3D geometry data. As is well-known, pipeline architectures may perform long latency operations more efficiently by splitting up the operation into a plurality of stages, where the output of each stage is coupled to the input of the next successive stage. Thus, the graphics processing pipeline 600 receives input data 601 that is transmitted from one stage to the next stage of the graphics processing pipeline 600 to generate output data 602. In an embodiment, the graphics processing pipeline 600 may represent a graphics processing pipeline defined by the OpenGL® API. As an option, the graphics processing pipeline 600 may be implemented in the context of the functionality and architecture of the previous Figures and/or any subsequent Figure(s).

As shown in FIG. 6, the graphics processing pipeline 600 comprises a pipeline architecture that includes a number of stages. The stages include, but are not limited to, a data assembly stage 610, a vertex shading stage 620, a primitive assembly stage 630, a geometry shading stage 640, a viewport scale, cull, and clip (VSCC) stage 650, a rasterization stage 660, a fragment shading stage 670, and a raster operations stage 680. In an embodiment, the input data 601 comprises commands that configure the processing units to implement the stages of the graphics processing pipeline 600 and geometric primitives (e.g., points, lines, triangles, quads, triangle strips or fans, etc.) to be processed by the stages. The output data 602 may comprise pixel data (e.g., color data) that is copied into a frame buffer or other type of surface data structure in a memory.

The data assembly stage 610 receives the input data 601 that specifies vertex data for high-order surfaces, primitives, or the like. The data assembly stage 610 collects the vertex data in a temporary storage or queue, such as by receiving a command from the host processor that includes a pointer to a buffer in memory and reading the vertex data from the buffer. The vertex data is then transmitted to the vertex shading stage 620 for processing.

The vertex shading stage 620 processes vertex data by performing a set of operations (e.g., a vertex shader or a program) once for each of the vertices. Vertices may be, e.g., specified as a 4-coordinate vector (e.g., <x, y, z, w>) associated with one or more vertex attributes (e.g., color, texture coordinates, surface normal, etc.). The vertex shading stage 620 may manipulate individual vertex attributes such as position, color, texture coordinates, and the like. In other words, the vertex shading stage 620 performs operations on the vertex coordinates or other vertex attributes associated with a vertex. Such operations commonly including lighting operations (e.g., modifying color attributes for a vertex) and transformation operations (e.g., modifying the coordinate space for a vertex). For example, vertices may be specified using coordinates in an object-coordinate space, which are transformed by multiplying the coordinates by a matrix that translates the coordinates from the object-coordinate space into a world space or a normalized-device-coordinate (NCD) space. The vertex shading stage 620 generates transformed vertex data that is transmitted to the primitive assembly stage 630.

The primitive assembly stage 630 collects vertices output by the vertex shading stage 620 and groups the vertices into geometric primitives for processing by the geometry shading stage 640. For example, the primitive assembly stage 630 may be configured to group every three consecutive vertices as a geometric primitive (e.g., a triangle) for transmission to the geometry shading stage 640. In some embodiments, specific vertices may be reused for consecutive geometric primitives (e.g., two consecutive triangles in a triangle strip may share two vertices). The primitive assembly stage 630 transmits geometric primitives (e.g., a collection of associated vertices) to the geometry shading stage 640.

The geometry shading stage 640 processes geometric primitives by performing a set of operations (e.g., a geometry shader or program) on the geometric primitives. Tessellation operations may generate one or more geometric primitives from each geometric primitive. In other words, the geometry shading stage 640 may subdivide each geometric primitive into a finer mesh of two or more geometric primitives for processing by the rest of the graphics processing pipeline 600. The geometry shading stage 640 transmits geometric primitives to the viewport SCC stage 650.

In an embodiment, the graphics processing pipeline 600 may operate within a streaming multiprocessor and the vertex shading stage 620, the primitive assembly stage 630, the geometry shading stage 640, the fragment shading stage 670, and/or hardware/software associated therewith, may sequentially perform processing operations. Once the sequential processing operations are complete, in an embodiment, the viewport SCC stage 650 may utilize the data. In an embodiment, primitive data processed by one or more of the stages in the graphics processing pipeline 600 may be written to a cache (e.g. L1 cache, a vertex cache, etc.). In this case, in an embodiment, the viewport SCC stage 650 may access the data in the cache. In an embodiment, the viewport SCC stage 650 and the rasterization stage 660 are implemented as fixed function circuitry.

The viewport SCC stage 650 performs viewport scaling, culling, and clipping of the geometric primitives. Each surface being rendered to is associated with an abstract camera position. The camera position represents a location of a viewer looking at the scene and defines a viewing frustum that encloses the objects of the scene. The viewing frustum may include a viewing plane, a rear plane, and four clipping planes. Any geometric primitive entirely outside of the viewing frustum may be culled (e.g., discarded) because the geometric primitive will not contribute to the final rendered scene. Any geometric primitive that is partially inside the viewing frustum and partially outside the viewing frustum may be clipped (e.g., transformed into a new geometric primitive that is enclosed within the viewing frustum. Furthermore, geometric primitives may each be scaled based on a depth of the viewing frustum. All potentially visible geometric primitives are then transmitted to the rasterization stage 660.

The rasterization stage 660 converts the 3D geometric primitives into 2D fragments (e.g. capable of being utilized for display, etc.). The rasterization stage 660 may be configured to utilize the vertices of the geometric primitives to setup a set of plane equations from which various attributes can be interpolated. The rasterization stage 660 may also compute a coverage mask for a plurality of pixels that indicates whether one or more sample locations for the pixel intercept the geometric primitive. In an embodiment, z-testing may also be performed to determine if the geometric primitive is occluded by other geometric primitives that have already been rasterized. The rasterization stage 660 generates fragment data (e.g., interpolated vertex attributes associated with a particular sample location for each covered pixel) that are transmitted to the fragment shading stage 670.

The fragment shading stage 670 processes fragment data by performing a set of operations (e.g., a fragment shader or a program) on each of the fragments. The fragment shading stage 670 may generate pixel data (e.g., color values) for the fragment such as by performing lighting operations or sampling texture maps using interpolated texture coordinates for the fragment. The fragment shading stage 670 generates pixel data that is transmitted to the raster operations stage 680.

The raster operations stage 680 may perform various operations on the pixel data such as performing alpha tests, stencil tests, and blending the pixel data with other pixel data corresponding to other fragments associated with the pixel. When the raster operations stage 680 has finished processing the pixel data (e.g., the output data 602), the pixel data may be written to a render target such as a frame buffer, a color buffer, or the like.

It will be appreciated that one or more additional stages may be included in the graphics processing pipeline 600 in addition to or in lieu of one or more of the stages described above. Various implementations of the abstract graphics processing pipeline may implement different stages. Furthermore, one or more of the stages described above may be excluded from the graphics processing pipeline in some embodiments (such as the geometry shading stage 640). Other types of graphics processing pipelines are contemplated as being within the scope of the present disclosure. Furthermore, any of the stages of the graphics processing pipeline 600 may be implemented by one or more dedicated hardware units within a graphics processor such as PPU 300. Other stages of the graphics processing pipeline 600 may be implemented by programmable hardware units such as the SM 440 of the PPU 300.

The graphics processing pipeline 600 may be implemented via an application executed by a host processor, such as a CPU. In an embodiment, a device driver may implement an application programming interface (API) that defines various functions that can be utilized by an application in order to generate graphical data for display. The device driver is a software program that includes a plurality of instructions that control the operation of the PPU 300. The API provides an abstraction for a programmer that lets a programmer utilize specialized graphics hardware, such as the PPU 300, to generate the graphical data without requiring the programmer to utilize the specific instruction set for the PPU 300. The application may include an API call that is routed to the device driver for the PPU 300. The device driver interprets the API call and performs various operations to respond to the API call. In some instances, the device driver may perform operations by executing instructions on the CPU. In other instances, the device driver may perform operations, at least in part, by launching operations on the PPU 300 utilizing an input/output interface between the CPU and the PPU 300. In an embodiment, the device driver is configured to implement the graphics processing pipeline 600 utilizing the hardware of the PPU 300.

Various programs may be executed within the PPU 300 in order to implement the various stages of the graphics processing pipeline 600. For example, the device driver may launch a kernel on the PPU 300 to perform the vertex shading stage 620 on one SM 440 (or multiple SMs 440). The device driver (or the initial kernel executed by the PPU 400) may also launch other kernels on the PPU 400 to perform other stages of the graphics processing pipeline 600, such as the geometry shading stage 640 and the fragment shading stage 670. In addition, some of the stages of the graphics processing pipeline 600 may be implemented on fixed unit hardware such as a rasterizer or a data assembler implemented within the PPU 400. It will be appreciated that results from one kernel may be processed by one or more intervening fixed function hardware units before being processed by a subsequent kernel on an SM 440.

### Machine Learning

Deep neural networks (DNNs) developed on processors, such as the PPU 300 have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions that are supported by the PPU 300. Inferencing is less compute-intensive than training, being a latency-sensitive process where a trained neural network is applied to new inputs it has not seen before to classify images, translate speech, and generally infer new information.

Neural networks rely heavily on matrix math operations, and complex multi-layered networks require tremendous amounts of floating-point performance and bandwidth for both efficiency and speed. With thousands of processing cores, optimized for matrix math operations, and delivering tens to hundreds of TFLOPS of performance, the PPU 300 is a computing platform capable of delivering performance required for deep neural network-based artificial intelligence and machine learning applications.

What is claimed is:

1. A system, comprising:
at least one processor to:
receive one or more parameters to be used in conjunction with one or more linear equations; and
generate one or more portions of a neural network based, at least in part, on whether the one or more parameters is to cause the one or more portions of the neural network to produce a valid result.

2. The system of claim 1, wherein the one or more linear equations is generated from a matrix of values that includes the one or more parameters.

3. The system of claim 2, wherein the matrix is generated based on defined constraints for:
a size of the matrix, and
a range for one or more of the values.

4. The system of claim 2, wherein the matrix defines a number of anchor nodes for the one or more portions of the neural network and connections between the anchor nodes.

5. The system of claim 1, wherein the one or more portions of the neural network is generated, using the one or more linear equations, by:
determining a volume of each anchor node of a plurality of anchor nodes in the one or more portions of the neural network, and
determining dimensions for each of the anchor nodes, based on the volume of the anchor node.

6. The system of claim 5, wherein the volume of each anchor node of the plurality of anchor nodes is determined by:
reducing the one or more linear equations such that each linear equation represents a volume of a respective anchor node as a function of a volume of one or more input anchor nodes of the anchor nodes,
determining, from the reduced one or more linear equations, integer scale factors for the anchor nodes,
determining a minimum valid volume for the one or more input anchor nodes, using the integer scale factors,
selecting a volume for each of the one or more input anchor nodes, based on the minimum valid volume determined for each of the one or more input anchor nodes, and
calculating a volume for each of the remaining anchor nodes, based on the selected volume for each of the one or more input anchor nodes and the reduced one or more linear equations.

7. The system of claim 5, wherein the dimensions include a sequence of values with a product equivalent to the volume of the anchor node.

8. The system of claim 5, wherein the one or more portions of the neural network is further generated by:
determining a function for each connection of a plurality of connections between the anchor nodes, based on the dimensions of the anchor nodes linked by the connection.

9. The system of claim 8, wherein the function for a respective one of the connections that links first and second ones of the anchor nodes includes one or more operations that transform the dimensions of the first anchor node to the dimensions of the second anchor node.

10. A non-transitory computer readable medium storing computer code executable by at least one processor to perform a method to:
receive as input a matrix of values including one or more parameters;
generate one or more linear equations from the matrix of values; and
generate one or more portions of a neural network, using the one or more linear equations, based, at least in part, on whether the one or more parameters is to cause the one or more portions of the neural network to produce a valid result.

11. The non-transitory computer readable medium of claim 10, wherein the matrix is generated based on defined constraints for:
a size of the matrix, and
a range for one or more of the values.

12. The non-transitory computer readable medium of claim 10, wherein the matrix defines a number of anchor nodes for the one or more portions of the neural network and connections between the anchor nodes.

13. The non-transitory computer readable medium of claim 10, wherein the one or more portions of the neural network is generated, using the one or more linear equations, by:
determining a volume of each anchor node of a plurality of anchor nodes in the one or more portions of the neural network, and
determining dimensions for each of the anchor nodes, based on the volume of the anchor node.

14. The non-transitory computer readable medium of claim 13, wherein the volume of each anchor node of the plurality of anchor nodes is determined by:
reducing the one or more linear equations such that each linear equation represents a volume of a respective anchor node as a function of a volume of one or more input anchor nodes of the anchor nodes,
determining, from the reduced one or more linear equations, integer scale factors for the anchor nodes,
determining a minimum valid volume for the one or more input anchor nodes, using the integer scale factors,
selecting a volume for each of the one or more input anchor nodes, based on the minimum valid volume determined for each of the one or more input anchor nodes, and
calculating a volume for each of the remaining anchor nodes, based on the selected volume for each of the one or more input anchor nodes and the reduced linear equations.

15. The non-transitory computer readable medium of claim 13, wherein the dimensions include a sequence of values with a product equivalent to the volume of the anchor node.

16. The non-transitory computer readable medium of claim 13, wherein the one or more portions of the neural network is further generated by:
determining a function for each connection of a plurality of connections between the anchor nodes, based on the dimensions of the anchor nodes linked by the connection.

17. The non-transitory computer readable medium of claim 16, wherein the function for a respective one of the connections that links first and second ones of the anchor nodes includes one or more operations that transform the dimensions of the first anchor node to the dimensions of the second anchor node.

18. A method to:
receive as input a matrix of values that defines a number of anchor nodes for one or more portions of a neural network and connections between the anchor nodes;
generate one or more linear equations from the matrix of values; and
generate the one or more portions of the neural network, using the one or more linear equations, based, at least in part, on whether the one or more portions of the neural network is to produce a valid result, wherein the one or more portions of the neural network is generated by:
determining a volume of each of the anchor nodes in the one or more portions of the neural network, using the one or more linear equations,
determining dimensions for each of the anchor nodes, wherein the dimensions include a sequence of values with a product equivalent to the volume of the anchor node, and
determining a function for each connection between the anchor nodes, based on the dimensions of the anchor nodes linked by the connection,
wherein the function for a respective one of the connections that links first and second ones of the anchor nodes includes one or more operations that transform the dimensions of the first anchor node to the dimensions of the second anchor node.

19. The method of claim 18, wherein the matrix is generated based on defined constraints for:
a size of the matrix, and
a range for one or more of the values.

20. The method of claim 18, wherein the volume of each anchor node of the plurality of anchor nodes is determined by:
reducing the one or more linear equations such that each linear equation represents a volume of a respective anchor node as a function of a volume of one or more input anchor nodes of the anchor nodes,
determining, from the reduced one or more linear equations, integer scale factors for the anchor nodes,
determining a minimum valid volume for the one or more input anchor nodes, using the integer scale factors,
selecting a volume for each of the one or more input anchor nodes, based on the minimum valid volume determined for each of the one or more input anchor nodes, and
calculating a volume for each of the remaining anchor nodes, based on the selected volume for each of the one or more input anchor nodes and the reduced linear equations.
